(19) United States
(12) Patent Application Publication
(10) Pub. No.: US 2015/0320634 A1
(43) Pub. Date: Nov. 12, 2015

(54) SCALP STIMULATION DEVICE

(71) Applicant: Sharlene A. Munro, Wellington, FL (US)

(72) Inventor: Sharlene A. Munro, Wellington, FL (US)

(21) Appl. No.: 14/709,502

(22) Filed: May 12, 2015

Related U.S. Application Data
(60) Provisional application No. 61/992,019, filed on May 12, 2014.

(51) Int. Cl. A61H 7/00

(52) U.S. Cl. CPC A61H 7/005; A61H 2205/021

(57) ABSTRACT

Arrangements directed to a scalp stimulation device are described. The scalp stimulation device can include a housing and a plurality of scalp engaging members. The plurality of scalp engaging members can be located at least partially within the housing. The scalp engaging members can be selectively extended from and/or selectively retracted into the housing.

### CROSS-REFERENCE TO RELATED APPLICATIONS

This application claims the benefit of U.S. Provisional Application No. 61/992,019, filed on May 12, 2014, which is incorporated herein by reference in its entirety.

### FIELD

The subject matter described herein relates in general to scalp care and, more particularly, to the stimulation of a scalp.

### BACKGROUND

For various reasons, a need may arise for a person to touch, rub, scratch or engage his or her head or scalp. However, there are reasons which prevent people from doing so. For instance, some people wear hair extensions. In such case, the user's natural hair is braided and held close to the head by netting. The netting also serves as an attachment point for the hair extensions, which are sewn or otherwise attached to the netting. However, the netting and extensions prevents or impedes direct access to the user's head. Thus, if a person wishes to scratch his or her head, the user may try to scratch through the netting, but such actions can damage, disrupt or shift the netting. As another example, an individual with natural hair may want to scratch his or her head. However, doing so may result in dirt and/or oil on a hand being transferred to the hair or head.

### SUMMARY

Arrangements relate to systems, methods and/or apparatus to engage and/or stimulate the head and/or scalp of a person. In one respect, arrangements are directed to a scalp stimulation device. The scalp stimulation device can include a housing and a plurality of scalp engaging members. The scalp engaging members can be selectively extended at least partially from the housing and/or selectively retracted at least partially into the housing. In one or more arrangements, the scalp engaging members can be selectively movable between a retracted position and an extended position.

In another respect, arrangements are directed to a scalp stimulation device. The scalp stimulation device includes a housing. The housing can include a main portion and a handle portion. The scalp stimulation device can include a plurality of scalp engaging members. The scalp engaging members can be located at least partially within the housing. The scalp engaging members can be selectively movable between a retracted position and an extended position. The scalp stimulation device can include one or more attachment elements operatively connected to the housing. The scalp stimulation device can include one or more decorative elements. The one or more decorative elements can be operatively connected to the housing. The one or more decorative elements can substantially obscure the housing.

### BRIEF DESCRIPTION OF THE DRAWINGS

FIG. 1 is an example of a scalp stimulation device, showing a plurality of scalp engaging members in an extended position.

FIG. 2 is an example of a scalp stimulation device, showing the plurality of scalp engaging members in a retracted position.

FIG. 3 is an example of one arrangement of a plurality of scalp engaging members, wherein the scalp engaging members are aligned in a row.

FIG. 4 is an example of one arrangement of a plurality of scalp engaging members, wherein the scalp engaging members are arranged in a plurality of aligned rows.

FIG. 5 is an example of one arrangement of a plurality of scalp engaging members, wherein the scalp engaging members are arranged in a plurality of offset rows.

FIG. 6 is an example of a scalp stimulation device, showing one manner of selectively extending and/or selectively retracting a plurality of scalp engaging members.

FIG. 7 is an example of a scalp stimulation device adapted to be worn by a user.

### DETAILED DESCRIPTION

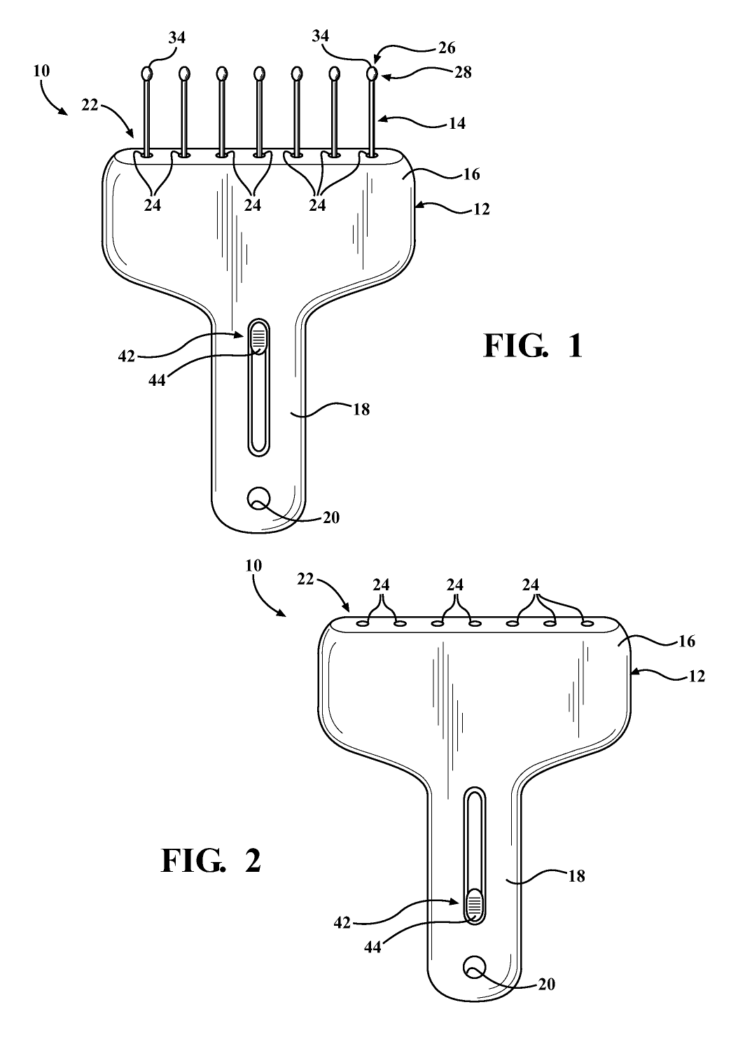

Arrangements described herein relate to systems, methods and/or apparatus to engage and/or stimulate the head and/or scalp of a person. Detailed embodiments are disclosed herein; however, it is to be understood that the disclosed embodiments are intended only as exemplary. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of embodiments and aspects herein. Arrangements are shown in FIGS. 1-7, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

Referring to FIGS. 1 and 2, an example of a scalp stimulation device 10 is shown. The scalp stimulation device 10 can include a housing 12 and a plurality of scalp engaging members 14. The scalp engaging members 14 can be selectively extended from and/or selectively retracted into the housing 12. FIG. 1 shows an example in which the plurality of scalp engaging members 14 are in an extended position. FIG. 2 shows an example in which the plurality of scalp engaging members 14 are in a retracted position. In some arrangements, the plurality of scalp engaging members 14 can be entirely located within the housing 12 when in the retracted position. In other arrangements, a portion of the plurality of scalp engaging members 14 can extend outside of the housing 12 when in the retracted position.

The housing 12 can be made of any suitable material. For instance, the housing 12 can be made of any suitable plastic and/or metal. The housing 12 can be a single piece construction. Alternatively, the housing 12 can be made of a plurality of housing portions, which can be joined together in any suitable manner, such as by one or more fasteners, one or more adhesives, and/or one or more forms of mechanical engagement, just to name a few possibilities.

The housing 12 can have any suitable configuration. In one or more arrangements, the housing 12 can have a main portion 16 and a handle portion 18. The main portion 16 can be configured to receive at least a portion of the plurality of scalp engaging members 14. At least a portion of the main portion 16 can be hollow.

The handle portion 18 can have any suitable configuration. The handle portion 18 can be elongated. The handle portion 18 can have any suitable cross-section shape. At least a portion of the handle portion 18 can be hollow. In one or more arrangements, the handle portion 18 can be non-hollow. The handle portion 18 and the main portion 16 can have any suitable arrangement. For instance, the main portion 16 can be arranged at about 90 degrees relative to the handle portion 18.

The handle portion 18 can be configured to facilitate engagement by a user. For instance, the handle portion 18 can include one or more ergonomic features, such as grips.

The housing 12 can be adapted to allow a user to attach one or more other items thereto (e.g. charms, beads, strings, yarns, ribbons, etc.). For instance, the handle portion 18 can include a hole 20 or other feature to facilitate attachment of such items.

The housing 12 can be configured to allow the scalp engaging members 14 to move into and out of the housing 12. The main portion 16 can include an exit region 22. The exit region 22 can include one or more features to allow such movement of the scalp engaging members 14. For instance, the exit region 22 can include one or more exit openings 24. In one or more arrangements, the plurality of scalp engaging members 14 can pass through a single exit opening 24. Alternatively, there can be a plurality of exit openings 24. In one or more arrangements, a subset of the plurality of scalp engaging members 14 can pass through each of the exit openings 24. In one or more arrangements, there can be an exit opening 24 for each individual scalp engaging member 14, as is shown in FIG. 1.

The housing 12 can be configured to provide a desired aesthetic appearance. To that end, any suitable ornamentation can be provided on the housing 12. For instance, various designs (e.g. animal prints, jewels, etc.) can be provided on the housing 12.

Again, the scalp stimulation device 10 can include a plurality of scalp engaging members 14. Each scalp engaging members 14 can have an elongated body. The scalp engaging members 14 can have any suitable length. For instance, the length of the scalp engaging members 14 can be from about 2 centimeters to about 5 centimeters. For example, the length of the scalp engaging members 14 can be about 2 centimeters, about 2.25 centimeters, about 2.5 centimeters, about 2.75 centimeters, about 3 centimeters, about 3.25 centimeters, about 3.5 centimeters, about 3.75 centimeters, about 4 centimeters, 4.25 centimeters, about 4.5 centimeters, about 4.75 centimeters, and about 5 centimeters.

It should be noted that these lengths can describe the overall length of the scalp engaging members 14, as measured from a first longitudinal end to a second opposite longitudinal end. Alternatively, these lengths can describe the protruding length of the scalp engaging members 14. The “protruding length” is the distance between a distal end 26 of a scalp engaging member 14 and the point at which the scalp engaging member 14 exits outside the housing 12 when the scalp engaging member 14 is in a fully extended position.

The scalp engaging members 14 can be made of any suitable material. The scalp engaging members 14 can be made of a flexible material that allows some bending of the scalp engaging members 14. In one or more arrangements, the scalp engaging members 14 can be made of plastic and/or metal. The scalp engaging members 14 can be made of a material and/or coated with a material that is resistant to degradation when exposed to oils, bacteria and/or chemicals.

The scalp engaging members 14 can have any suitable cross-sectional shape. In one or more arrangements, the scalp engaging members 14 can have a substantially circular cross-section shape. As used herein, the term “substantially” includes exactly the term it modifies and slight variations therefrom. Thus, the term “substantially circular” means exactly circular and slight variations therefrom.

However, it will be understood that embodiments are not limited to this shape. Indeed, the scalp engaging members 14 can be substantially rectangular, substantially triangular, substantially oval, substantially parallelogram, substantially polygonal, substantially trapezoidal shape, just to name a few possibilities. In some instances, the scalp engaging members 14 can have an irregular cross-sectional shape.

The scalp engaging members 14 can be substantially straight along their length. Alternatively, the scalp engaging members 14 can be non-straight in one or more regions. In one or more arrangements, the scalp engaging members 14 can be curved across their entire length.

In one or more arrangements, the scalp engaging members 14 can have any suitable cross-sectional size. For instance, the scalp engaging members 14 can be sized to fit in the openings in hair netting, including standard hair netting and/or any non-standard hair netting. Such hair netting can include openings that can have a substantially circular, honeycomb or other shape. In one or more arrangements, the scalp engaging members 14 can have a cross-sectional diameter or thickness from about ⅛ inch to about ¼ inch. Again, the sizing of the scalp engaging members 14 with respect to the openings in hair netting is merely one example, and embodiments are not limited to this arrangement.

The cross-sectional size of the scalp engaging elements 14 can be substantially constant along their length. However, in some instances, the cross sectional size of one or more of the scalp engaging members 14 can vary over at least a portion of its length. For instance, an end region 28 and/or other region of one or more of the scalp engaging members 14 can be tapered.

There can be any suitable quantity of the scalp engaging members 14. In one or more implementations, there can be at least three scalp engaging members 14. In one or more implementations, there can be four, five, six, seven or eight scalp engaging members 14. In one or more implementations, there can be more than eight scalp engaging members 14.

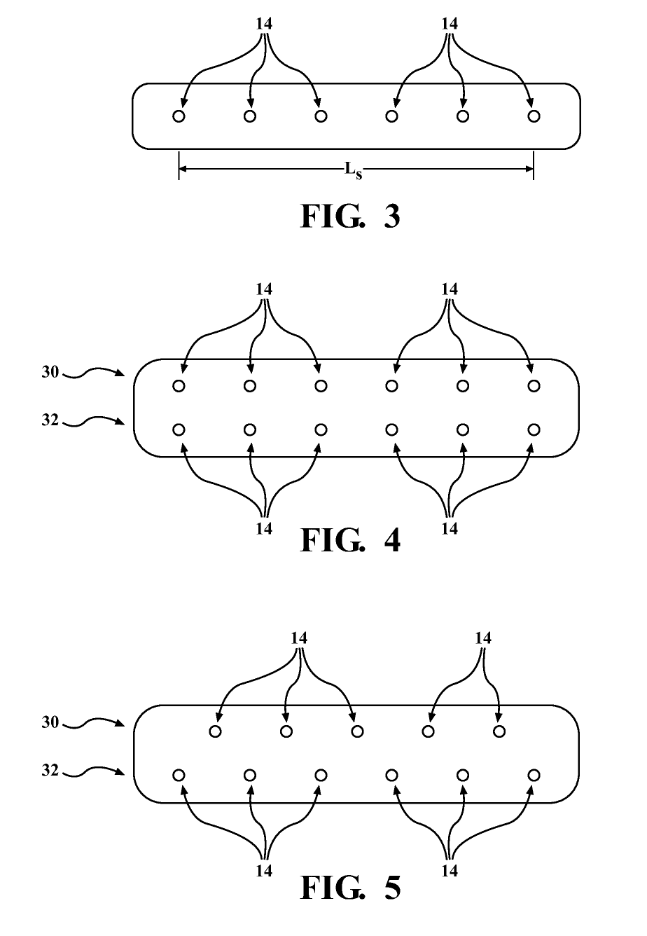

The scalp engaging members 14 can be arranged in any suitable manner. In one or more implementations, the plurality of scalp engaging members 14 can be substantially aligned in one or more rows. In one or more arrangements, the plurality of scalp engaging members can be substantially aligned in a single row, as is shown in FIG. 3.

In one or more arrangements, the plurality of scalp engaging members 14 can be arranged into a plurality of rows. FIG. 4 shows an example in which the scalp engaging members 14 are arranged in two rows. In such case, the scalp engaging members 14 of a first row 30 can be substantially aligned with the scalp engaging members 14 in a second row 32. FIG. 5 shows another example in which the scalp engaging members 14 in the first row 30 are offset from the scalp engaging members 14 in the second row 32. While FIGS. 4 and 5 show two rows 30, 32 of scalp engaging members 14, it will be understood that arrangements can include more than two rows of scalp engaging members 14.

Further, the plurality of scalp engaging members 14 can be arranged in ways other than described above. As an example, in one or more implementations, the scalp engaging members 14 can be arranged in a random manner.

In one or more arrangements, the scalp engaging members 14 can be substantially parallel to each other. In one or more arrangements, one or more of the scalp engaging members 14 can be non-parallel to the other scalp engaging members 14.

The scalp engaging members 14 can be distributed in any suitable manner. For instance, the spacing between the scalp engaging members 14 can be substantially equal. In one or more arrangements, the spacing between the scalp engaging members 14 can be about 1 centimeter. However, in other arrangements, the spacing between one or more pairs of neighboring the scalp engaging members 14 can be non-equal to the spacing other pairs of neighboring scalp engaging members 14.

The distribution of the scalp engaging members 14 can be spread out over any suitable distance. In one or more arrangements, the distance Ls (FIG. 3) between the two laterally outer scalp engaging members 14 can be from about 5 centimeters to about 6 centimeters.

The scalp engaging members 14 can be configured to protect a scalp from abrasion and/or to otherwise provide comfortable engagement with a user's head or scalp. As an example, in one or more implementations, the distal ends 26 of the scalp engaging members 14 can be provided with an end element 34. The end element 34 can be larger than the cross-sectional diameter or thickness of the scalp engaging member 14 at least in the end region 28 thereof. In one or more arrangements, the end element 34 can have any suitable rounded shape. For instance, the end element 34 can be substantially spherical, substantially semi-spherical, substantially cylindrical, substantially oval, substantially oblong or other suitable shape, just to name a few possibilities. The end element 34 can be made of any suitable material, such as rubber or plastic. The end element 34 can be made of a soft material and/or a material that will not irritate or discomfort human skin. The end element 34 can be made of a material and/or coated with a material that is resistant to degradation when exposed to oils, bacteria and/or chemicals.

The scalp engaging members 14 can be substantially identical to each other. Alternatively one or more of the scalp engaging members 14 can be different from the other scalp engaging members 14 in one or more respects, including in any of the respects described above. For instance, one or more of the scalp engaging members 14 can have a different size, shape, length, material, rounded end element from the other scalp engaging members 14, just to name a few possibilities.

As noted above, the plurality of scalp engaging members 14 can be selectively extended from and/or selectively retracted into the housing 12. The selective extension and/or selective retraction of the plurality of scalp engaging members 14 can be achieved in any suitable manner. In one or more arrangements, the scalp stimulation device 10 can be configured so that the selective extension and/or selective retraction can be performed for all of the plurality of scalp engaging members 14 simultaneously. Alternatively, the scalp stimulation device 10 can be configured so that the selective extension and/or selective retraction can be performed for each scalp engaging member 14 individually. Still further, the scalp stimulation device 10 can be configured so that the selective extension and/or selective retraction can be performed for a plurality of subsets of the plurality of scalp engaging members 14. Each subset can include one or more of the scalp engaging members 14.

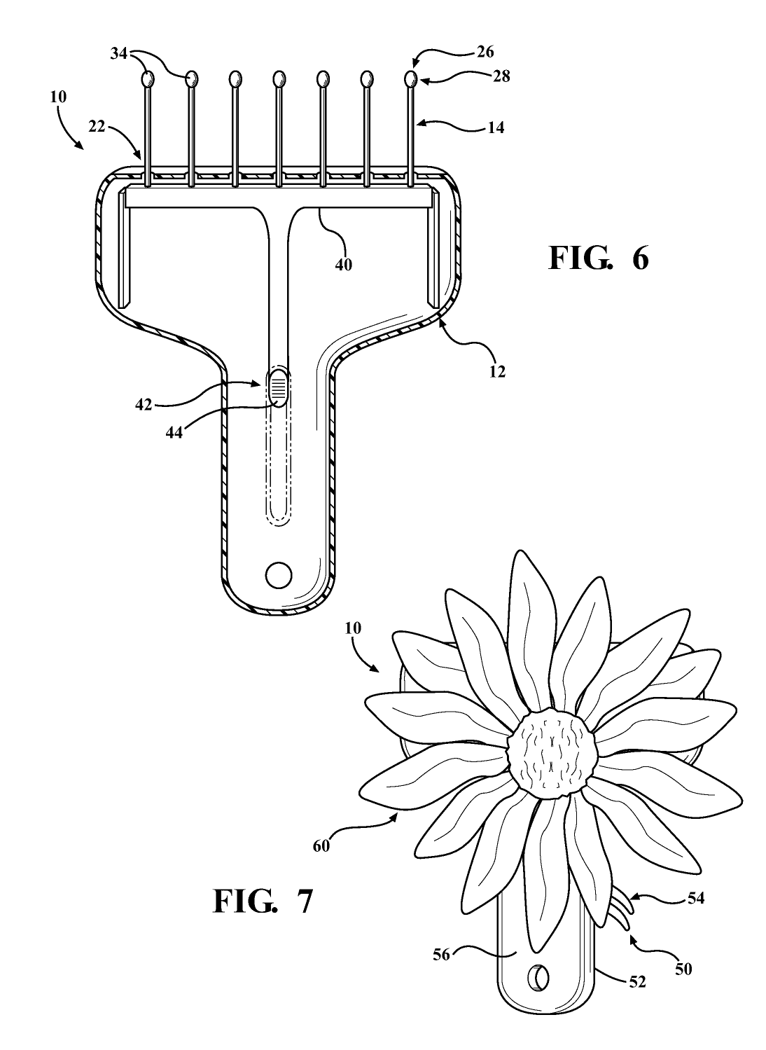

One possible manner of providing for selective extension and/or selective retraction is shown in FIG. 6. However, it will be understood that embodiments are not limited to this arrangement. The plurality of scalp engaging members can be operatively connected to a common base element 40. The term “operatively connected” can include direct or indirect connections, including connections without direct physical contact. For instance, the plurality of scalp engaging members 14 can be formed with the base element 40 as a unitary structure. Alternatively, the plurality of scalp engaging members 14 can be formed separately from the base element 40 and subsequently connected thereto, such as by one or more fasteners, one or more adhesives, one or more forms of mechanical engagement, welding, and/or brazing, just to name a few possibilities.

The base element 40 can be operatively connected to user interface element 42, such as a finger slide 44, a push/pull rod, lever, trigger, button, and/or protrusion. At least a portion of the user interface element 42 can extend outside of the housing 12 or can be otherwise accessible by a user, allowing a user to engage the user interface element 42. A user can engage the user interface element 42 to selectively extend and/or selectively retract the plurality of scalp engaging members 14.

In one or more arrangements, the scalp stimulation device 10 can be configured to have one or more extended positions. Further, the scalp stimulation device 10 can be configured to retain the scalp engaging elements 14 in a desired position. In some arrangements, the scalp stimulation device 10 can be configured to bias one or more of the scalp engaging members 14 can into a retracted position or an extended position. The scalp stimulation device 10 can include any suitable structure(s), component(s), means, and/or feature(s) to provide one or more of such functionalities.

In some instances, the scalp stimulation device 10 can be adapted to be worn by a user, and, more particularly, worn by a user in an inconspicuous manner. For instance, the scalp stimulation device 10 can be adapted to be worn as a hair ornament and/or a clothing accessory. An example of such an arrangement is shown in FIG. 7.

In one or more implementations, the scalp stimulation device 10 can be configured for attachment to a person's hair or clothing. To that end, the scalp stimulation device 10 can include one or more attachment elements 50. In one or more arrangements, the attachment element 50 can be formed separately from the housing 12 and attached to the housing 12. In one or more other arrangements, the attachment element 50 can be formed with the housing 12 as a unitary structure. The attachment element 50 can be provided in any suitable location on the housing 12. In one or more arrangements, the attachment element can be provided on an under side 52 of the housing 12.

The attachment element 50 can be any suitable structure. As an example, the attachment element 50 can be a hair clip 54. As another example, the attachment element 50 can be a barrette, pin, safety pin, clamp, clasp, just to name a few possibilities.

Further, the scalp stimulation device 10 can be configured to provide a decorative or ornamental appearance. To that end, the scalp stimulation device 10 can include one or more decorative elements 60. The decorative element 60 can be directly or indirectly attached to the housing 12 in any suitable manner. For instance, the decorative element 60 can be attached to the housing 12 by one or more fasteners, one or more adhesives, and/or one or more forms of mechanical engagement, just to name a few possibilities.

The decorative element 60 can have any suitable form. For instance, the decorative element 60 can be one or more artificial flowers, one or more plants, one or more jewels, one or more crystals, one or more animals, one or more butterflies, and/or one or more dragonflies, just to name a few possibilities. The decorative element 60 can be provided in any suitable location on the housing 12. In one or more arrangements, the decorative element 60 can be provided on an upper side 56 of the housing 12.

The decorative piece 60 can be sized, shaped, configured and/or arranged so that the scalp stimulation device 10 and/or the purpose of the scalp stimulation device 10 is not apparent and/or is not easily discernable to an observer when the scalp stimulation device 10 is worn by a person. In one or more arrangements, the decorative piece 60 can be larger than the housing 12. As a result, the housing 12 can be substantially obscured by the decorative element. In one or more arrangements, the decorative element 60 may be smaller than the housing 12 such that a portion of the housing 12 is visible.

Now that the various aspects of the identification tag have been described, various methods of using the identification tag will now be presented. Various possible methods of use will be described. The methods of use described may be applicable to the embodiments described in relation to FIGS. 1-7, but it is understood that the method can be carried out with other suitable systems and arrangements. Moreover, the method may include other steps that are not described, and in fact, the methods are not limited to including every step described herein. Moreover, the described steps are not limited to the particular chronological order described. Indeed, some of the steps may be performed in a different order than what is described and/or at least some of the steps described can occur simultaneously.

A user can manipulate the scalp stimulation device 10 such that the plurality of scalp engaging members 14 are moved into the extended position. The user can manipulate the scalp stimulation device 10 so as to bring the distal ends of the scalp engaging members 14 into contact with a portion of the user's head or scalp. In instances in which the user is wearing hair netting, the arrangement of the scalp engaging members 14 can facilitate the insertion of the scalp engaging members 14 into the openings in the netting. The user can manipulate the scalp stimulation device 10 so that the scalp engaging members 14 rub or stimulate the user's scalp or head. The user can withdraw the scalp stimulation device 10 from his or her head. The user can retract the scalp engaging members 14 into the housing 12 of the scalp stimulation device 10. The user can store the scalp stimulation device 10, or wear the scalp stimulation device 10 as described above.

The scalp engaging members can be used by any person to scratch, soothe or stimulate his or her scalp. The scalp engaging members can work with all hair types and all hair extensions, including full sew in, partial sew in, micro links, fusion, clip ins, braids, twists, dreadlocks. For individuals with hair extensions, the scalp engaging members can fit in the openings in the netting to directly engage a user's scalp without damaging or shifting the netting.

It will be appreciated that arrangements described herein can provide numerous benefits. For instance, the device can be used to stimulate a user's scalp and/or provide relief from an itch or otherwise. As a result, normal hair growth can be facilitated. Further, hair and/or scalp health can be facilitated. Further, the device can provide such stimulation and/or relief without damaging or shifting the hair netting worn by a user. Moreover, the device can avoid a user from contacting the scalp and/or hair with fingers or other portion of the body that could impart oils, dirt and other substances onto the scalp and/or hair.

The device can be used in connection with any type of hair type or hair arrangement. For instance, the device can be used with natural hair or synthetic hair. In addition, the device can be used with braids, dreadlocks, extensions, microlinks, etc. While arrangements described herein are beneficial for users of hair products in which a user wears hair netting, it will be appreciated that the benefits provided herein are not limited to such applications. Indeed, arrangements described herein can be used by individuals with their natural hair without wearing netting or other hair-related product.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

Aspects described herein can be embodied in other forms and combinations without departing from the spirit or essential attributes thereof. Thus, it will of course be understood that embodiments are not limited to the specific details described herein, which are given by way of example only, and that various modifications and alterations are possible.

What is claimed is:

1. A scalp stimulation device, comprising:
a housing including a main portion and a handle portion; and
a plurality of scalp engaging members located at least partially within the housing, the scalp engaging members being selectively movable between a retracted position and an extended position, at least a portion of the scalp engaging members extend outside of the housing when in the extended position.

2. The scalp stimulation device of claim 1, wherein in the retracted position, the plurality of scalp engaging members is entirely located within the housing.

3. The scalp stimulation device of claim 1, wherein the housing defines a plurality of exit openings, and wherein each of the plurality of scalp engaging members is at least partially received in a respective one of the exit openings.

4. The scalp stimulation device of claim 1, wherein the scalp engaging members can have an associated length, and wherein the length of the scalp engaging members is from about 2 centimeters to about 5 centimeters.

5. The scalp stimulation device of claim 1, wherein the scalp engaging members are substantially straight along their length.

6. The scalp stimulation device of claim 1, wherein the scalp engaging members have an associated cross-sectional thickness, and wherein the cross-sectional thickness is from about ⅛ inch to about ¼ inch.

7. The scalp stimulation device of claim 1, wherein the scalp engaging members are substantially aligned in a single row.

8. The scalp stimulation device of claim 1, wherein the scalp engaging members are substantially aligned in a plurality of rows, and wherein the scalp engaging members of a first row are substantially aligned with the scalp engaging members in a second row.

9. The scalp stimulation device of claim 1, wherein the scalp engaging members are substantially aligned in a plurality of rows, and wherein the scalp engaging members of a first row are offset from the scalp engaging members in a second row.

10. The scalp stimulation device of claim 1, wherein the spacing between the plurality of scalp engaging members is substantially equal.

11. The scalp stimulation device of claim 1, wherein a lateral distance is defined between the two laterally outermost scalp engaging members, and wherein the lateral distance is from about 5 centimeters to about 6 centimeters.

12. The scalp stimulation device of claim 1, wherein the scalp engaging members include distal ends, and wherein the distal ends are configured to protect a scalp from abrasion.

13. The scalp stimulation device of claim 12, wherein the distal ends include an end element, and wherein the cross-sectional size of the end element is larger than the cross-sectional size of the of the scalp engaging member in at least an end region of the scalp engaging member.

14. The scalp stimulation device of claim 1, further including one or more attachment elements operatively connected to the housing.

15. The scalp stimulation device of claim 14, wherein the one or more attachment elements are hair clips.

16. The scalp stimulation device of claim 1, further including one or more decorative elements, wherein the one or more decorative elements are operatively connected to the housing, and wherein the one or more decorative elements substantially obscure the housing.

17. The scalp stimulation device of claim 1, wherein the one or more decorative elements are artificial plants or artificial flowers.

18. A scalp stimulation device, comprising:
a housing, the housing including a main portion and a handle portion;
a plurality of scalp engaging members located at least partially within the housing, the scalp engaging members being selectively movable between a retracted position and an extended position;
one or more attachment elements operatively connected to the housing; and
one or more decorative elements, the one or more decorative elements being operatively connected to the housing, and the one or more decorative elements substantially obscuring the housing.

19. The scalp stimulation device of claim 18, wherein the one or more attachment elements are hair clips.

20. The scalp stimulation device of claim 18, wherein the scalp engaging members are substantially aligned in one or more rows.
